(19) United States
(12) Patent Application Publication
(10) Pub. No.: US 2010/0196575 A1
(43) Pub. Date: Aug. 5, 2010

(54) Melting Vegetable Protein Based Substitute Cheese

(75) Inventors: Rosa I. Sanchez, St. Louis, MO (US); Matthew K. McMindes, Chesterfield, MO (US)

Correspondence Address: Solae, LLC, 4300 Duncan Avenue, Legal Department E4, St. Louis, MO, 63110, US

(73) Assignee: SOLAE, LLC, St. Louis, MO (US)

(21) Appl. No.: 12/697,889

(22) Filed: Feb. 1, 2010

Related U.S. Application Data
(60) Provisional application No. 61/148,544, filed on Jan. 30, 2009.

(51) Int. Cl. A23C 20/02; A23C 20/00

(52) U.S. Cl. 426/578; 426/573

(57) ABSTRACT

This invention is directed to a molded, pressed, low animal fat substitute cheese composition, comprising;
moisture in an amount that is at least about 50% by weight of the cheese composition, and
(A) a vegetable protein material;
(B) a vegetable oil triglyceride; and
(C) a hydrocolloid.

In another embodiment, the molded, pressed, low animal fat substitute cheese compositions further comprises at least one component selected from the group consisting of
(D) a cheese flavorant and
(E) a starch.

### FIELD OF THE INVENTION

The present invention relates to a molded, pressed, low animal fat substitute cheese composition prepared from vegetable proteins wherein the resulting molded, pressed, low animal fat substitute cheese composition has good melt characteristics.

### BACKGROUND OF THE INVENTION

The general public has become increasingly aware of the need to control the intake of animal fats and cholesterol in their diets. Dairy products, particularly cheese products are regarded as a significant source of saturated animal fats and cholesterol. Medical studies have concluded that human consumption of such animal fats and cholesterol should be limited in order to avoid such maladies as coronary heart disease. The general recommendation has thus been to greatly reduce and even eliminate consumption of cheese which is a concentrated source of such detrimental, unhealthy animal fats and cholesterol. This recommendation is rapidly becoming accepted by the public and is resulting in substantial decrease in the consumption of cheese food products. Substantial efforts have been mounted over the past ten years to discover a method and article of manufacture of low animal fat, low cholesterol cheese with the flavor and texture of normal cheese. It has been determined that the presence of animal fat is important in obtaining the right body and texture of the finished cheese, and the animal fat also has an important role in the flavor of the product. All of these features affect consumer acceptability of the product.

In this diet and calorie conscious era, skim milk cheddar cheese would appear to be destined for greater popularity, but the fact is that the cheese has no appetizing characteristics. It is without much cheese flavor and body texture is usually very hard. Rapid drying out of the cheese during cooking is a characteristic feature, despite the normal low cooking temperature of 31° C. (88° F.).

Cheese compositions are generally prepared from dairy liquids by processes that include treating the liquid with a coagulating or clotting agent. The coagulating agent may be a curding enzyme, an acid, or a suitable bacterial culture or it may include such a culture. The coagulum or curd that results generally incorporates transformed casein, animal fats including natural butter fat, and flavorings that arise especially when a bacterial culture is used. The curd is usually separated from the whey. The resulting liquid whey generally contains soluble proteins not affected by the coagulation; such proteins are, of course, not incorporated into the coagulum.

The art of cheese making has been practiced for a number of years. The need to increase the amount of cheese from a given amount of milk is an economic necessity when the milk supply is limited, but the demand for such product is high. Soy protein has been used as an extender in cheeses with limited success. The patent literature is rich with patents which proclaim the ability to solve the various problems associated with using soy protein in a milk based fresh cheese. To date, none of the patents have described methods or products which have been commercial successes due to either the difficulty in incorporating the soy protein isolate into the finished cheese or because of quality issues with the finished product.

Typical soy cheese is a cheese-like product made from soymilk that comes in full, low, and nonfat versions and in a variety of types including cheddar, mozzarella, and Parmesan. There is also a soy cream cheese, sold in plain and seasoned versions. Most soy cheeses contain casein, a milk protein, so dairy-sensitive individuals should read labels carefully. Cheese lovers find the flavor and texture of soy cheeses inferior, largely because they have a significantly lower animal fat content than their dairy counterparts. Most soy versions are best enjoyed chilled or at room temperature; many separate when heated.

It is important to note that some commercial products which contain soymilk or soy cheese also contain dairy proteins such as whey or casein (caseinates) that some people want to avoid due to allergies or diet preferences.

Cheese and cheese products are highly nutritious and popular in a variety of prepared foods and snack items. Several categories of hard, semi-soft and soft cheeses exist. Natural cheeses, i.e., Cheddar, Mozzarella, Romano, Blue, Parmesan, Cream and the like, are produced without further processing or adding other ingredients, while pasteurized processed cheese, i.e., American, spread and the like, entails further addition of ingredients and pasteurization. The aforementioned cheeses have standard compositional identities. On the other hand, cheese substitutes and cheese analogs, made from dairy and/or non-dairy ingredients, have no such standard identities. If a cheese does not comply with a standard identity and contains essentially similar components to a standard cheese, but chemical and/or physical properties (i.e. % fat, % moisture) exist outside common levels, the cheese may be referred to as a cheese product.

Typically, cheese is not shelf stable at room temperature, and requires special packaging and refrigeration during all phases of shipping, handling, and marketing. Otherwise, spoilage will take place. Such rigid and exacting requirements during packaging and refrigeration limits the scope in which cheese can be utilized, particularly in industrial applications where many production facilities may lack refrigerated storage space. Furthermore, such a strict requirement for refrigeration limits distribution of cheese and related products in under-developed and developing countries where refrigeration facilities are not commonplace. Further limitations exist where storage precludes effective refrigeration.

Carrageenan has been used in a number of instances to enhance production of cottage cheese and soft acid set coagulated cheeses. These methods have involved the use of carrageenan to tie up protein material from the whey thereby increasing the yield levels. Such methods encompass substantially different functionality for the carrageenan, different pH levels, use of different chemical and biological constituents and different processing parameters, such as different temperatures, compared to the instant invention.

### SUMMARY OF THE INVENTION

The present invention is directed to a molded, pressed, low animal fat substitute cheese composition, comprising:
(A) moisture in an amount that is at least about 50% by weight of the cheese composition, and
(B) a vegetable protein material;
(C) a vegetable oil triglyceride; and
(D) a hydrocolloid.

In another embodiment, the molded, pressed, low animal fat substitute cheese composition further comprises at least one component selected from the group consisting of:
a cheese flavorant and
a starch.

### DETAILED DESCRIPTION OF THE INVENTION

Substitute and imitation cheese are commonly called “analog” cheese. These cheeses typically use casein, a milk by-product and vegetable oil in place of milk solids. They offer functional advantages as well as cost savings.

Substitute cheese is nutritionally equivalent to the natural or process cheese for which it substitutes. Imitation cheese is similar to substitute cheese except imitation cheese is not nutritionally equivalent.

In general, cheese compositions may be classified as either natural cheese compositions or non-natural cheese compositions. However, the classification of cheese compositions may vary within the cheese industry.

As used herein, the term “cheese composition” refers to a composition used to make cheese product or the final product of cheese itself. For example, “cheese composition” could refer to a composition during one or more stages of cheese manufacturing, such as when cheese composition ingredients are being mixed together. As another example, “cheese composition” could refer to a mixture of cheese ingredients being mixed and heated. Or, as yet another example, “cheese composition” could refer to a composition that is in the form of a final cheese product, ready to be sold for human consumption such as a snack (e.g., the cheese composition could be in the form of shredded cheese, diced cheese, a cheese sauce, combinations of these, and the like).

Natural cheese compositions can be characterized as being made directly from milk. Moreover, the United States Department of Agriculture (USDA) has specific standards for natural cheese compositions including ingredients used, manufacturing procedures used, and final nutritional value. Natural cheese is well known and is commercially available.

Non-natural cheese compositions can include substitute cheese compositions, process cheese substitutes, and imitation cheese compositions.

In general, a “substitute cheese composition,” means a product that is a substitute for, and resembles another cheese, yet is not nutritionally inferior (21 C.F.R. §§101.3 and 102.5). The respective entireties of which references are incorporated herein by reference, defines substitute and imitation food products (e.g., cheese compositions). A substitute mozzarella cheese is further defined by 21C.F.R. §§133.3, 133.5, and 133.155, the respective entireties of which references are incorporated herein by reference.

In contrast to natural cheese compositions and non-natural cheese compositions, an “imitation cheese” composition means a cheese composition that resembles another cheese but is nutritionally inferior.

The present invention is a molded, pressed, low animal fat substitute cheese composition. Dairy protein is optionally present at not more than about 5% by weight of the molded, pressed, low animal fat substitute cheese compositions, preferably at not more than about 3% by weight of the molded, pressed, low animal fat substitute cheese compositions, and most preferably at not more than about 1% by weight of the molded, pressed, low animal fat substitute cheese compositions. The dairy protein is selected from the group consisting of casein, whey protein, and mixtures thereof.

Animal fat is any fat obtained from animals. Animal fat is high in saturated fatty acids. Animal fat is defined as a soft greasy substance at room temperature that occurs in organic tissue and consists of a mixture of lipids (mostly triglycerides). Examples of animal fat are tallow (beef fat), ghee (butter fat), lard (pork fat), chicken fat, blubber, and cod liver oil. In the present invention, animal fat may be present in the cheese composition at not more than about 5% by weight of the molded, pressed cheese composition, preferably at not more than about 3% by weight of the molded, pressed cheese composition, and most preferably at not more than about 1% by weight of the molded, pressed cheese composition.

This invention provides molded, pressed, low animal fat substitute cheese compositions while providing one or more suitable functional, organoleptic, and nutritional properties of natural cheese compositions. Molded, pressed low animal fat substitute cheese compositions of this invention are characterized as having casein protein replaced with a combination of ingredients including an amount of non-casein protein (e.g., non-dairy protein such as a vegetable protein) and an amount of a hydrocolloid and a vegetable oil triglyceride. Significantly, molded, pressed, low animal fat substitute cheese compositions of the invention are characterized as having one or more suitable functional, organoleptic, and nutritional properties even as the level of casein protein is reduced to levels otherwise known to decrease such desired properties. Applicants' inventive molded, pressed, low animal fat substitute cheese composition is not necessarily limited to one or more specific cheese composition classification(s), but is directed to a cheese composition generally, wherein it is desired to reduce the casein protein level to zero while providing or maintaining one or more suitable functional, organoleptic, or nutritional properties. The cheese compositions of this invention are non-natural cheese compositions and specifically molded, pressed, low animal fat substitute cheese compositions.

In general, molded, pressed, low animal fat substitute cheese compositions of the invention include mozzarella cheese compositions, cheddar cheese compositions, American cheese compositions, and the like. Preferred cheese compositions include mozzarella substitute cheese compositions. Cheese compositions of the invention can be combined with other ingredients to produce other food products that include cheese (e.g., snack food) including pizza, pizza-type snack food, and the like. Preferred food products include mozzarella substitute cheese compositions of the invention.

In general, molded, pressed, low animal fat substitute cheese compositions of the invention include in addition to moisture, a vegetable protein component, a vegetable protein triglyceride component, and a hydrocolloid component. Cheese compositions of the invention preferably also include a starch component, and a cheese flavorant component. Optionally, molded, pressed, low animal fat substitute cheese compositions of the invention can include dairy protein as well as various other additives.

Moisture is present in the molded, pressed, low animal fat substitute cheese composition. In a preferred embodiment, the moisture is present in an amount of at least about 50% by weight of the composition. It also is preferred that moisture be present in an amount of between about 55% by weight to about 90% by weight, and it is more preferably in the range of between about 60% to about 80% by weight of the composition. In a most preferred embodiment, moisture may be present in an amount of about 70% by weight of the composition. The moisture is present as added moisture to the molded, pressed, low animal fat substitute cheese composition.

(A) The Vegetable Protein Material

The vegetable protein material is selected from the group consisting of protein derived from soybeans, corn, peas, canola seeds, sunflower seeds, rice, amaranth, lupin, rape seeds, and mixtures thereof. A preferred vegetable protein material is soy protein derived from soybeans. The soy protein is selected from the group consisting of a soy protein isolate, a soy protein concentrate, a soy protein flour, and mixtures thereof. The soy protein material which is useful within the present invention is a soy protein isolate. The term “soy protein” typically refers to processed, edible dry soybean products other than animal feed meals. Many types are produced for use in human and pet foods and milk replacers and starter feeds for young animals.

The traditional processes for making the soy protein isolates is as follows. Soybeans entering a processing plant must be sound, mature, yellow soybeans. The soybeans can be washed to remove dirt and small stones. They are typically screened to remove damaged beans and foreign materials, and may be sorted to uniform size.

Each cleaned raw soybean is then cracked into several pieces, typically six (6) to eight (8), to produce soy chips and hulls. The hulls are removed by aspiration. Alternatively, the hulls may be loosened by adjusting the moisture level and mildly heating the soybeans before cracking. Hulls can also be removed by passing cracked pieces through corrugated rolls revolving at different speeds. In these methods, the hulls are then removed by a combination of shaker screen and aspiration.

The soy chips, which contain about 11% moisture, are then conditioned at about 60° C. and flaked to about 0.25 millimeter thickness. The resulting flakes are then extracted with an inert solvent, such as a hydrocarbon solvent, typically hexane, in one of several types of countercurrent extraction systems to remove the soybean oil. Hexane extraction is basically an anhydrous process, as with a moisture content of only about 11%, there is very little water present in the soybeans to react with the protein. For soy protein flours, soy protein concentrates and soy protein isolates, it is important that the flakes be desolventized in a manner which minimizes the amount of cooking or toasting of the soy protein to preserve a high content of water-soluble soy protein. This is typically accomplished by using vapor desolventizers or flash desolventizers. The flakes resulting from this process are generally referred to as “edible defatted flakes.” Specially designed extractors with self-cleaning, no-flake-breakage features, and the use of a narrow boiling range hexane are recommended for producing edible defatted flakes.

The resulting edible defatted flakes, which are the starting material the soy protein isolate, have a protein content of approximately 50%. Moisture content has typically been reduced by 3% to 5% during this process. Any residual solvent may be removed by heat and vacuum.

The edible defatted flakes are then milled, usually in an open-loop grinding system, by a hammer mill, classifier mill, roller mill or impact pin mill first into grits, and with additional grinding, into soy flours with desired particle sizes. Screening is typically used to size the product to uniform particle size ranges, and can be accomplished with shaker screens or cylindrical centrifugal screeners.

Soy protein isolate, as the term is used herein, refers to a soy protein material containing at least about 90% or greater protein content, and preferably from about 92% or greater protein content (mfb). The remaining components are soy fiber material, fats, minerals, and sugars such as sucrose, raffinose and stachyose. The edible defatted flakes are placed in an aqueous bath to provide a mixture having a pH of at least about 6.5 and preferably between about 7.0 and 10.0 in order to extract the protein. Typically, if it is desired to elevate the pH above 6.7, various alkaline reagents such as sodium hydroxide, potassium hydroxide and calcium hydroxide or other commonly accepted food grade alkaline reagents may be employed to elevate the pH. A pH of above about 7.0 is generally preferred, since an alkaline extraction facilitates solubilization of the soy protein. Typically, the pH of the aqueous extract of soy protein will be at least about 6.5 and preferably about 7.0 to 10.0. The ratio by weight of the aqueous extractant to the edible defatted flakes is usually between about 20 to 1 and preferably a ratio of about 10 to 1. Before continuing a work-up of the extract, the extract is centrifuged to remove insoluble carbohydrates. A second extraction is performed on the insoluble carbohydrates to remove any additional soy protein. The second extract is centrifuged to give any further insoluble carbohydrates and a second aqueous extract. The first and second extracts are combined for the work-up. The insoluble carbohydrates are used to obtain the soy fiber. In an alternative embodiment, the soy protein is extracted from the edible defatted flakes with water, that is, without a pH adjustment.

It is also desirable in obtaining the soy protein isolate used in the present invention, that an elevated temperature be employed during the aqueous extraction step, either with or without a pH adjustment, to facilitate solubilization of the protein, although ambient temperatures are equally satisfactory if desired. The extraction temperatures which may be employed can range from ambient up to about 49° C. (120° F.) with a preferred temperature of 32° C. (90° F.). The period of extraction is further non-limiting and a period of time between about 5 to 120 minutes may be conveniently employed with a preferred time of about 30 minutes. Following extraction of the soy protein material, the aqueous extract of soy protein can be stored in a holding tank or suitable container while a second extraction is performed on the insoluble solids from the first aqueous extraction step. This improves the efficiency and yield of the extraction process by exhaustively extracting the soy protein from the residual solids from the first step.

The combined, aqueous soy protein extracts from both extraction steps, without the pH adjustment or having a pH of at least 6.5, or preferably about 7.0 to 10, are then precipitated by adjustment of the pH of the extracts to, at or near the isoelectric point of the soy protein to form an insoluble curd precipitate. The pH to which the soy protein extracts are adjusted is typically between about 4.0 and 5.0. The precipitation step may be conveniently carried out by the addition of a common food grade acidic reagent such as acetic acid, sulfuric acid, phosphoric acid, hydrochloric acid or with any other suitable acidic reagent. The soy protein precipitates from the acidified extract, and is then separated from the extract. The separated soy protein may be washed with water to remove residual soluble carbohydrates and ash from the protein material and the residual acid can be neutralized to a pH of from about 4.0 to about 6.0 by the addition of a basic reagent such as sodium hydroxide or potassium hydroxide. At this point the soy protein material is subjected to a pasteurization step. The pasteurization step kills microorganisms that may be present. Pasteurization is carried out at a temperature of at least 180° F. for at least 10 seconds, at a temperature of at least 190° F. for at least 30 seconds or at a temperature of at least 195° F. for at least 60 seconds. The soy protein material is then dried using conventional drying means to form a soy protein isolate. Soy protein isolates are commercially available from Solae® LLC, (St. Louis, Mo.) for example, as SUPRO® 220, SUPRO® 219D, SUPRO® 780, SUPRO® 783, SUPRO® Plus 651, SUPRO® 670, and SUPRO® XF.

Soy protein concentrates useful as the soy protein material are commercially available. For example, soy protein concentrates Promine™ DSPC, Alpha® 10, Alpha® 12, Alpha® DS, and Alpha® 5800 are available from Solae, LLC (St. Louis, Mo.). Soy protein concentrates useful in the present invention may also be produced from commodity soybeans according to conventional processes in the soy protein manufacturing industry. For example, defatted soy flakes, soy flour, soy grits, or soy meal produced as described above may be washed with aqueous ethanol (preferably about 60% to about 80% aqueous ethanol) to remove soluble carbohydrates from the soy protein and soy fiber. The soy protein and soy fiber containing material is subsequently dried to produce the soy protein concentrate. Alternatively, the defatted soy flakes, soy flour, soy grits, or soy meal may be washed with an aqueous acidic wash having a pH of from between about 4.3 to about 4.8 to remove soluble carbohydrates from the soy protein and soy fiber. After removing the soluble carbohydrates, water is added and the pH is adjusted to between about 6.5 and about 7.5. The soy protein and soy fiber containing material is subsequently dried to produce the soy protein concentrate.

The soy protein material used in the present invention, may be modified to enhance the characteristics of the soy protein material. The modifications are modifications which are known in the art to improve the utility or characteristics of a protein material and include, but are not limited to, denaturation and hydrolysis of the protein material.

The soy protein material is denatured and hydrolyzed to lower the viscosity. Chemical denaturation and hydrolysis of protein materials is well known in the art and typically consists of treating an aqueous soy protein material with one or more alkaline reagents in an aqueous solution under controlled conditions of pH and temperature for a period of time sufficient to denature and hydrolyze the protein material to a desired extent. Typical conditions utilized for chemical denaturing and hydrolyzing a soy protein material are: a pH of up to about 10, preferably up to about 9.7; a temperature of between about 50° C. (122° F.) to about 80° C. (176° F.) and a time period of between about 15 minutes to about 4 hours, where the denaturation and hydrolysis of the aqueous protein material occurs more rapidly at higher pH and temperature conditions.

Hydrolysis of the soy protein material may be effected by treating the soy protein material with an enzyme capable of hydrolyzing the soy protein. Many enzymes are known in the art which hydrolyze protein materials, including, but not limited to, fungal proteases, pectinases, lactases, and chymotrypsin. Enzyme hydrolysis is effected by adding a sufficient amount of enzyme to an aqueous dispersion of the soy protein material, typically from between about 0.1% to about 10% enzyme by weight of the soy protein material, and treating the enzyme and soy protein material at a temperature, typically from between about 5° C. (41° F.) to about 75° C. (167° F.), and a pH, typically from between about 3 to about 9, at which the enzyme is active for a period of time sufficient to hydrolyze the soy protein material. After sufficient hydrolysis has occurred the enzyme is deactivated by heating to a temperature above 75° C. (167° F.), and the soy protein material is precipitated by adjusting the pH of the solution to about the isoelectric point of the soy protein material. Enzymes having utility for hydrolysis in the present invention include, but are not limited to, bromelain and Alcalase®.

The soy protein material is a low viscosity soy protein material when measured at a concentration of 12% in water and at a temperature of between about 21° C. and 23° C. The viscosity of the soy protein material typically is not higher than about 25 centipoise and preferably is not higher than about 20 centipoise. The procedure for determining the viscosity follows.

The soy protein material may be present in the molded, pressed, low animal fat substitute cheese composition in an amount of between about 5% by weight to about 30% by weight of the composition, preferably between about 8% by weight to about 20% by weight of the composition, and most preferably between about 10% by weight to about 15% by weight of the composition.

Added to a glass pint blender jar fitted with a blade assembly are 220 milliliters of deionized water at a temperature of about 26° C. About 30 grams of a protein sample are weighed and slowly added to the blender jar. The jar is capped and vigorously shaken for about 10 seconds to disperse the protein and to keep the protein from adhering to the sides of the jar. The contents are then blended for about 60 seconds using the lowest speed of the blender. The blended protein slurry is then transferred to a 600 milliliter beaker and three drops of antifoam are added and combined into the slurry. The beaker is covered and placed into a water bath at about 60° C. The water level of the bath is between about the 300-400 milliliter mark. The contents are mechanically stirred at 60 revolutions per minute for about 15 minutes. At the end of this time, the contents are hand stirred to dissipate foam into the slurry. Mechanical stirring is resumed for about an additional 15 minutes. The beaker and its contents are then placed in a water bath having a temperature of about 1° C. The contents are mechanically stirred at 60 revolutions per minute for about 6 minutes, followed by hand stirring for about 5 seconds. The contents are at a temperature of between about 21° C. and about 23° C. and are transferred into a 180 milliliter electrolytic beaker. Using a spindle #1 at 60 revolutions per minute, a viscosity reading is read from the viscometer.

### The Vegetable Oil Triglyceride

While fats and oils are both classified as triglycerides, the triglycerides of the present invention are non-animal derived. That is, these triglycerides are vegetable oil triglycerides not animal fat triglycerides.

The vegetable oil triglycerides are of the formula

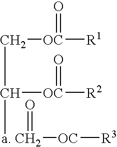

wherein R¹, R², and R³ are independently saturated or unsaturated aliphatic hydrocarbyl groups that contain from about 7 to about 23 carbon atoms. The term “hydrocarbyl group” as used herein denotes a radical having a carbon atom directly attached to the remainder of the molecule. The aliphatic hydrocarbyl groups include the following:

Aliphatic hydrocarbon groups; that is, alkyl groups such as heptyl, nonyl, decyl, undecyl, tridecyl, heptadecyl, octyl; alkenyl groups containing a single double bond such as heptenyl, nonenyl, undecenyl, tridecenyl, heptadecenyl, heneicosenyl; alkenyl groups containing 2 or 3 double bonds such as 8,11-heptadecadienyl and 8,11,14-heptadecatrienyl, and alkynyl groups containing the triple bonds. All isomers of these are included, but straight chain groups are preferred.

Substituted aliphatic hydrocarbon groups; that is groups containing non hydrocarbon substituents which, in the context of this invention, do not alter the predominantly hydrocarbon character of the group. Those skilled in the art will be aware of suitable substituents; examples are hydroxy, carbalkoxy, (especially lower carbalkoxy) and alkoxy (especially lower alkoxy), the term “lower” denoting groups containing not more than 7 carbon atoms.

Hetero groups; that is, groups which, while having predominantly aliphatic hydrocarbon character within the context of this invention, contain atoms other than carbon present in a chain or ring otherwise composed of aliphatic carbon atoms. Suitable hetero atoms will be apparent to those skilled in the art and include, for example, oxygen, nitrogen and sulfur.

Naturally occurring triglycerides are vegetable oil. The preferred vegetable oil triglycerides comprise coconut oil, palm oil, palm kernel oil, sunflower oil, safflower oil, corn oil, soybean oil, olive oil, canola oil (a low content of a monounsaturated omega-9 fatty acid), and rapeseed oil (a high content of a monounsaturated omega-9 fatty acid). The synthetic triglycerides are those formed by the reaction of one mole of glycerol with three moles of a fatty acid or mixture of fatty acids. The fatty acids contain from about 6 to about 22 carbon atoms. The preferred fatty acids comprise the saturated acids of caprylic acid, capric acid, lauric acid, myristic acid, palmitic acid, and stearic acid. The monounsaturated acids are eicosanoic acid, triconanoic acid, and oleic acid, Examples of polyunsaturated acids are linoleic acid and linolenic acid.

The vegetable triglyceride oils can be synthetic or derived from a plant. For example, triglycerides such as triolein, trieicosenoin, or trierucin can be used as starting materials. Triglyceride oils are available commercially or can be synthesized using standard techniques. Plant derived oils, i.e., vegetable oils, are particularly useful starting materials, as they allow oils of the invention to be produced in a cost-effective manner. Suitable vegetable oils that have a saturated fatty acid content of at least about 50%, based on total fatty acid content include, for example, coconut oil, palm oil, and palm kernel oil. Vegetable oil triglycerides having a saturated fatty acid content of at least about 70% are of value. The saturated fatty acid content can be composed of, for example, lauric acid (C12), myristic acid (C14), palmitic acid (C16), stearic acid (C18) and combinations thereof.

Coconut oil is a vegetable oil consisting of about 90% saturated fat. The oil contains predominantly medium chain triglycerides, with roughly 92% saturated fatty acids, 6% monounsaturated fatty acids, and 2% polyunsaturated fatty acids. Of the saturated fatty acids, coconut oil is primarily 44.6% lauric acid, 16.8% myristic acid, 8.2% palmitic acid and 8% caprylic acid, although it contains seven different saturated fatty acids in total. Its only monounsaturated fatty acid is oleic acid while its only polyunsaturated fatty acid is linoleic acid.

Palm oil and palm kernel oil are composed of fatty acids, esterified with glycerol just like any ordinary fat. Both are high in saturated fatty acids, about 50% and 80%, respectively. Of the saturated fatty acids, palm oil is primarily 44.3% palmitic acid and 4.6% stearic acid. Its monounsaturated fatty acid is 38.7% oleic acid while its only polyunsaturated fatty acid is 10.5% linoleic acid. Of the saturated fatty acids, palm kernel oil is primarily 48.2% lauric acid, 16.2% myristic acid, 8.4% palmitic acid, 2.5% stearic acid, 3% capric acid, and 3% caprylic acid. Its monounsaturated fatty acid is 15.3% oleic acid while its only polyunsaturated fatty acid is 2.3% linoleic acid.

Vegetable oil triglycerides having an unsaturated fatty acid content and polyunsaturated fatty acid content are also of value. Suitable vegetable oil triglycerides have a monounsaturated fatty acid content of at least about 50%, based on total fatty acid content, and include, for example, rapeseed oil (both Brassica napus and B. campestris), peanut oil (Arachis hypogaea), olive oil (Olea europaea), sunflower oil (Helianthus annus), soybean oil (Glycine max), corn oil (Zea mays), crambe oil (Crambe abyssinica), and meadowfoam oil (Limnanthes alba) oil. Canola oil, which has less than 2% erucic acid, is a useful rapeseed oil. Additional oils such as palm or peanut oil that can be modified to have a high monounsaturated content also are suitable. Oils having a monounsaturated fatty acid content of at least about 70% are particularly useful. The monounsaturated fatty acid content can be composed of, for example, oleic acid (C18:1), eicosenoic acid (C20:1), erucic acid (C22:1), or combinations thereof.

Oils having an oleic acid content of between about 70% to about 90% are particularly useful. For example, IMC-130 canola oil, available from Cargill, Inc. (Minneapolis, Minn.), has an oleic acid content of about 75%, and a polyunsaturated fatty acid content (C18:2 and C18:3) of about 14%. U.S. Pat. No. 5,767,338 describes plants and seeds of IMC 130. See also U.S. Pat. No. 5,861,187. High oleic sunflower oils having oleic acid contents, for example, of between about 77% to about 81%, or between about 86% to about 92%, can be obtained from A. C. Humko, Memphis, Tenn. U.S. Pat. No. 4,627,192 describes high oleic acid sunflower oils.

Vegetable oil triglycerides having a high eicosenoic acid content include meadowfoam oil. Typically, meadowfoam oil has an eicosenoic acid content of between about 60% to about 65%. Such oil is sold by The Fanning Corporation (Chicago, Ill.) under the trade name “Fancor® Meadowfoam® Seed Oil”

Vegetable oil triglycerides having a high erucic acid content include high erucic acid rapeseed (HEAR) oil, and crambe oil. HEAR oil has an erucic acid content of between about 45% to about 55%, and is commercially available, for example, from CanAmera Foods (Saskatoon, Canada). For example, a high erucic acid rapeseed line that is sold under the trade name Hero is useful. Other high erucic acid varieties such as Venus, Mercury, Neptune or S89-3673 have erucic acid contents of about 50% or greater and also can be used. McVetty, P. B. E. et al., Can. J. Plant Sci., 76(2):341-342 (1996); Scarth, R. et al., Can. J. Plant Sci., 75(1):205-206 (1995); and McVetty, P. B. E. et al., Can. J. Plant Sci., 76(2):343-344 (1996). Crambe oil has an erucic acid content of between about 50% to about 55%, and is available from AgGrow Oils LLC, Carrington, N. Dak.

The vegetable oil(s) are present in the molded, pressed, low animal fat substitute cheese composition, in an amount sufficient to provide the composition with an acceptable mouth feel. A person of ordinary skill in the art will recognize that this amount will vary depending on the vegetable oil(s) qualities used in a given composition. More precisely, the vegetable oil(s) may be present in the molded, pressed, low animal fat substitute cheese composition, in an amount of between about 10% by weight to about 30% by weight of the composition, preferably between about 12% by weight to about 25% by weight of the composition, and most preferably between about 15% by weight to about 20% by weight of the composition.

### The Hydrocolloid

Hydrocolloids for use in the low animal fat cheese composition of the present invention include any hydrocolloid or other food grade thickeners, any or all of which will hereinafter be referred to as “hydrocolloids.” Hydrocolloids include a food grade hydrocolloid or mixture thereof known in the art capable of forming a gel-like, supportive matrix. Suitable hydrocolloids include, but are not limited to, food grade gums, such as guar gum, pectin, locust bean gum, xanthan gum, ghatti gum, and mixtures of such gums. Other useful hydrocolloids include gelatin, carboxymethylcellulose (CMC), tragacanth and plant-derived hydrocolloids, such as agar, alginate, carrageenan (kappa, iota, and lambda), and mixtures thereof. Preferred hydrocolloids include, for example, agar, pectin, xanthan gum, guar gum, locust bean gum, carboxymethylcellulose (CMC), and carrageenan (kappa, iota, and lambda) and mixtures of such. A most preferred hydrocolloid is carrageenan. Cellulose or cellulose-derived hydrocolloids like CMC can be used as a hydrocolloid; however, if used in significant quantities, the resulting composition may possess an undesirable, bad-tasting, tough finished product.

In some embodiments, cellulose in an amount of up to about 10% of the composition may be included. The presence of cellulose increases the amount of dietary fiber in the composition, an attractive feature for many consumers.

In any case, the selected hydrocolloid(s) are present in the low animal fat cheese composition in an amount sufficient to provide to the composition a formable body which can be molded or pressed into traditional cheese shapes such as loaves, logs, balls, chunks, or slabs. A person of ordinary skill in the art will recognize that this amount will vary depending on the water management qualities and/or gelling capacity of the particular hydrocolloids used in a given composition. More precisely, the hydrocolloid(s) may be present in the low animal fat cheese composition in an amount of between about 0.01% by weight to about 10% or more by weight of the composition, preferably between about 0.1% by weight to about 5% by weight of the composition, and most preferably between about 0.5% by weight to about 4% by weight of the composition. In one embodiment, the low animal fat cheese composition includes a hydrocolloid in an amount of between about 1% by weight to about 3% by weight of the total low animal fat cheese composition.

The most preferred hydrocolloids are carrageenans or carrageenins and are a family of linear sulphated polysaccharides extracted from red seaweeds. The name is derived from a type of seaweed that is abundant along the Irish coastline. Gelatinous extracts of the Chondrus crispus seaweed have been used as food additives for hundreds of years, though analysis of carrageenan safety as an additive continues.

Carrageenans are large, highly flexible molecules which curl forming helical structures. This gives them the ability to form a variety of different gels at room temperature. They are widely used in the food and other industries as thickening and stabilizing agents. A particular advantage is that they are pseudoplastic—they thin under shear stress and recover their viscosity once the stress is removed. This means that they are easy to pump but stiffen again afterwards.

There are three main commercial classes of carrageenan: Kappa—strong, rigid gels that are produced from Kappaphycus cottonii, Iota—soft gels that are produced from Eucheuma spinosum, and Lambda—form gels when mixed with proteins rather than water, used to thicken dairy products. The most common source is Gigartina from Southern Europe.

Many red algal species produce different types of carrageenans during their developmental history. For instance, the genus Gigartina produces mainly Kappa carrageenans during its gametophytic stage, and Lambda carrageenans during its sporophytic stage.

All are soluble in hot water, but in cold water only the Lambda form (and the sodium salts of the other two) are soluble.

When used in food products, carrageenan has the EU additive E-number E407 or E407a when present as “Processed eucheuma seaweed”. Although introduced on an industrial scale in the 1930s, the first use was in China around 600 BC (where Gigartina was used) and in Ireland around 400 AD.

The largest producer is the Philippines, where cultivated seaweed produces about 80% of the world supply. The most commonly used are Cottonii (Kappaphycus alvarezii, K. striatum) and Spinosum (Eucheuma denticulatum), which together provide about three quarters of the world production. These grow at sea level down to about 2 meters. The seaweed is normally grown on nylon lines strung between bamboo floats and harvested after three months or so when each plant weighs around 1 kg.

The Cottonii variety has been reclassified as Kappaphycus cottonii by Maxwell Doty (1988), thereby introducing the genus Kappaphycus, on the basis of the phycocolloids produced (namely kappa carrageenan).

After harvest, the seaweed is dried, baled, and sent to the carrageenan manufacturer. There the seaweed is ground, sifted to remove impurities such as sand, and washed thoroughly. After treatment with hot alkali solution (e.g. 5-8% potassium hydroxide), the cellulose is removed from the carrageenan by centrifugation and filtration. The resulting carrageenan solution is then concentrated by evaporation. It is dried and ground to specification.

The molded, pressed, low animal fat cheese composition may further comprise at least on component selected from the group consisting of
a cheese flavorant and
a starch.

### The Cheese Flavorant

The molded, pressed, low animal fat substitute cheese compositions may also contain a cheese flavorant.

Cheese flavorants or flavors are produce from the enzymatic degradation of carbohydrates, proteins, and triacylglycerols during aging, and are influenced by composition, manufacturing parameters, and storage conditions. Lactate and citrate, the salts of the organic acids in cheese, are metabolized by starter bacteria and nonstarter microflora, resulting in flavor compounds such as acetate, diacetyl, and 2,3-butanediol. Proteolysis of casein results in formation of peptides and free amino acids. Free amino acids and the smaller peptides are partly responsible for bitter, salty, sour, sweet, and umami taste descriptors. Triacylglycerols are hydrolyzed to mono- and diglycerides, glycerol, and free fatty acids. Short- and intermediate-chain free fatty acids, such as butyric acid and capric acid provide characteristic flavors.

In this specific invention, the cheese flavorant can be composed of the following food flavorings; cheese powders, enzyme modified cheese flavors and cheese flavors. The manufacture of cheese powders involves the production of pasteurized process cheeses which is then spray dried. The blend is selected from the group consisting of natural cheese, water, emulsifying salts, flavoring agents, colors and filling materials. Enzyme modified cheese flavors can be used which have usually 5-20 times stronger flavor than natural cheeses. The production of the enzyme modified cheeses consists in a production of the cheese curd, formation of a paste by blending the curd with emulsifying salts and water, pasteurization, addition of enzyme, incubation for 24-72 hours, pasteurization, homogenization and drying.

The cheese flavorant may be present in the molded, pressed, low animal fat substitute cheese composition in an amount of between about 0.01% by weight to about 3% by weight of the composition, preferably between about 0.1% by weight to about 2% by weight of the composition, and most preferably between about 0.5% by weight to about 1% by weight of the composition.

### The Starch

The molded, pressed, low animal fat substitute cheese composition may also contain a starch. The term “starch” as used herein, is intended to include all starches derived from any native source, any of which may be suitable for use herein. A native starch as used herein, is one as it is found in nature. Also suitable are starches derived from a plant obtained by standard breeding techniques including crossbreeding, translocation, inversion, transformation or any other method of gene or chromosome engineering to include variations thereof. In addition, starch derived from a plant grown from artificial mutations and variations of the above generic composition, which may be produced by known standard methods of mutation breeding, are also suitable herein.

Typical sources for the starches are cereals, tubers, roots, legumes and fruits. The native source can be a waxy variety of corn (maize), pea, potato, sweet potato, banana, barley, wheat, rice, oat, sago, amaranth, tapioca (cassaya), arrowroot, canna, and sorghum particularly maize, potato, cassaya, and rice. As used herein, the term “waxy” or “low amylose” is intended to include a starch containing no more than about 10% by weight amylose. Particularly suitable in the invention are those starches which contain no more than about 5% amylose by weight.

The term “gluten free starch” relates to modified tapioca starch, the main ingredient in many of bakery mix products. Gluten free or substantially gluten free starches are made from wheat-, corn-, and tapioca-based starches and are “gluten-free” because they do not contain gluten from wheat, oats, rye or barley—a factor of particular importance for people diagnosed with celiac disease and/or wheat allergies.

The starch may be present in the molded, pressed, low animal fat substitute cheese composition in an amount of between about 0.1% by weight to about 5% by weight of the composition, preferably between about 0.5% by weight to about 4% by weight of the composition, and most preferably between about 1% by weight to about 3% by weight of the composition.

The following example relates to the preparation of a soy protein isolate having utility in this invention.

### Example 1

A soy protein isolate is prepared in which 180 pounds per minute of defatted soybean flakes are added to an extraction tank to which is added 1080 pounds per minute of water which is heated to about 32° C. (90° F.). The soy flakes are extracted for a period of 30 minutes after which the aqueous solution is separated from the extracted flakes by centrifugation. The first aqueous extract is held while the extracted flake residue is redispersed in 720 pounds per minute of water at a temperature of 32° C. (90° F.). The pH of the mixture at this point is 6.8.

A second aqueous extract from the flakes is obtained by centrifugation and combined with the first aqueous extract. To the combined extracts, 37% hydrochloric acid is added to adjust the pH to about 4.5 and precipitate the protein. The precipitated protein is then centrifuged to remove excess liquid to a solids level of 20-25% by weight. The precipitated protein is then diluted with water to form a slurry having a solids level of 13.7% by weight. The pH of the slurry is adjusted to about 7.2 by the addition of an aqueous combination of sodium hydroxide and potassium hydroxide.

A mixture of calcium hydroxide and water is prepared by adding 1300 pounds calcium hydroxide to 52,000 pounds water, with stirring. The calcium hydroxide is permitted to disperse in the water for 1 hour. An amount of 85% phosphoric acid (1600 pounds) is added over a 30 minute period. At the end of the acid addition, the contents are permitted to stir for an additional 30 minutes. The slurry is transferred to a Gaulin homogenizer (model 15MR) and homogenized at 1500 pounds per square inch. The resulting hydrated gel of tricalcium phosphate has a solids content of 3.21%.

The hydrated gel is added in an amount sufficient to provide a calcium level of 3.0% by weight of the protein solids on a dry basis and the fortified slurry was allowed to equilibrate for 1 hour. The pH is about 7.0. The calcium fortified slurry is then homogenized as above and passed through a jet cooker at a pressure of 85 pounds per square inch. The steam heats the slurry in the jet cooker to a temperature of 152° C. (305° F.). After 8-10 seconds, progressive portions of the heated slurry are discharged.

At a temperature of about 52° C. (125° F.), the pH of the calcium fortified slurry is adjusted to between about 8 and 10 with a combination of aqueous sodium and potassium hydroxide. Alcalase®, 0.069, pounds and 0.037 pounds of bromelain are added to hydrolyze the protein.

At the end of the hydrolysis procedure, the protein slurry is passed through a jet cooker at a pressure of 85 pounds per square inch. The steam heats the slurry in the jet cooker to about 152° C. (305° F.). After 8-10 seconds, progressive portions of the heated slurry are discharged at about 60° C. (140° F.).

At the end of the heat treatment, the contents are transferred to a spray drier and dried in a manner that the protein particles agglomerate.

The soy protein isolate has a viscosity of 20 centipoise, a particle size of about of 80% retained on a 140 mesh screen and a density of about 0.34 g/ml.

The below examples are directed to the molded, pressed, low animal fat substitute cheese composition of this invention.

### Example 2

Water (129.2 g) at a temperature of 75° C. (167° F.) is added to a food processor followed by 23.07 g of SUPRO® 220 having a viscosity of 20 centipoise and 5.54 g of carrageenan. The contents are combined at high speed for one minute. Palm oil (13.3 g) and 20.12 g coconut oil are added and combined at high speed for two minutes. Then added are 0.46 g sodium ascorbate, 1.85 g cheese flavorant, and 1.85 g table salt. The contents are combined at high speed for five minutes. Then added are 4.61 g starch and the contents are combined at high speed for one minute. The temperature is increased to about 90° C. (194° F.). The contents are cooled to room temperature and placed in a mold.

### Example 3

Water (123 g) at a temperature of 75° C. (167° F.) is added to a food processor followed by 26.35 g of SUPRO® 220 and 5.27 g of carrageenan. The contents are combined at high speed for one minute. Palm oil (12.65 g) and 19.15 g coconut oil are added and combined at high speed for two minutes. Then added are 0.44 g sodium ascorbate, 3.51 g lactic acid, 0.88 g salt, 2.64 g annatto, and 1.76 g dextrose. The contents are combined at high speed for five minutes. Then added are 4.39 g starch and the contents are combined at high speed for one minute. The temperature is increased to about 90° C. (194° F.). The contents are cooled to room temperature and placed in a mold.

### Example 4

Water (126.8 g) at a temperature of 75° C. (167° F.) is added to a food processor followed by 22.57 g of SUPRO® 220 and 5.50 g of carrageenan. The contents are combined at high speed for one minute. Palm oil (12.95 g) and 19.82 g coconut oil are added and combined at high speed for two minutes. Then added are 0.39 g sodium ascorbate, 0.79 g lactic acid, 0.002 g annatto, 5.30 g chedderease 310, and 1.37 g Edlong® cheese flavor. The contents are combined at high speed for five minutes. Then added are 4.51 g starch and the contents are combined at high speed for one minute. The temperature is increased to about 90° C. (194° F.). The contents are cooled to room temperature and placed in a mold.

### Example 5

Water (132.24 g) at a temperature of 75° C. (167° F.) is added to a food processor followed by 23.62 g of SUPRO® 220 and 5.68 g of carrageenan. The contents are combined at high speed for one minute. Palm oil (13.62 g) and 20.60 g coconut oil are added and combined at high speed for two minutes. Then added are 0.48 g sodium ascorbate, 1.9 g cheese flavorant, and 1.9 g table salt. The contents are combined at high speed for five minutes. The temperature is increased to about 90° C. (194° F.). The contents are cooled to room temperature and placed in a mold.

Meltability is an important property of cheese, processed and imitation cheese, especially in applications of cheese as toppings or ingredients in prepared consumer foods (Wang & Sun, 2002). The measurement of cheese meltability is complicated due to the melting behavior which is dependent on both the thermal phase change characteristics of the solid cheese and the rheological properties of the melt, which are highly interdependent. Empirical techniques are generally employed in the cheese industry for determining cheese meltability due to their simplicity and speed. The most common methods in use are the Olson and Price test, in which the distance of the flow of melted cheese is measured; the Arnott test, in which meltability is expressed in terms of sample thickness before and after heating, and the Schreiber test, in which the circumference of a melted cheese disc is taken as an index of meltability.

The present inventors have made a very simple cheese test procedure that measures the sliceability of a melted cheese as well as its meltability. These two attributes are measured on a scale of 1 to 5 and compared against a 100% dairy cheddar cheese that is rated as a “5” on both sliceability and meltability, as a control sample. A rating of a “1” on sliceability means that the inventive sample is too soft to cut. A rating of a “5” on sliceability means that the inventive sample is equal to the control sample. A rating of a “1” on meltability means that the inventive sample does not melt. A rating of a “5” on meltability means that the inventive sample is equal to the control sample. A 30 gram control sample of a 100% dairy cheddar cheese identified as Cracker Barrel Natural Sharp cheese, available from Kraft Foods® and 30 gram samples of the cheese preparations of Examples 2-5 are heated in a 60° C. oven for 5 minutes. The results are tabulated in Table 1 below.

TABLE 1

| Cheese Source | Sliceability | Meltability |
|---|---|---|
| Control Sample | 5 | 5 |
| Example 2 | 2 | 3 |
| Example 3 | 2 | 3 |
| Example 4 | 2 | 4 |
| Example 5 | 3 | 4 |

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A molded, pressed, low animal fat substitute cheese composition, comprising;
moisture in an amount that is at least about 50% by weight of the cheese composition, and
(A) a vegetable protein material;
(B) a vegetable oil triglyceride; and
(C) a hydrocolloid.

2. The cheese composition of claim 1 further comprising at least one component selected from the group consisting of
(D) a cheese flavorant and
(E) a starch.

3. The cheese composition of claim 1 wherein the vegetable protein material is selected from the group consisting of legumes, corn, peas, canola, sunflowers, sorghum, rice, amaranth, potato, tapioca, arrowroot, canna, lupin, rape, wheat, oats, rye, barley, and mixtures thereof.

4. The cheese composition of claim 1 wherein the vegetable protein material is a soy protein material.

5. The cheese composition of claim 4 wherein the soy protein material is selected from the group consisting of soy protein flour, soy protein concentrate, soy protein isolate, and mixtures thereof.

6. The cheese composition of claim 5 wherein the soy protein material is a soy protein isolate.

7. The cheese composition of claim 6 wherein the soy protein isolate is present at between about 5% by weight to about 30% by weight of the composition.

8. The cheese composition of claim 6 wherein the soy protein isolate is present at between about 8% by weight to about 20% by weight of the composition.

9. The cheese composition of claim 6 wherein the soy protein isolate is present at between about 10% by weight to about 15% by weight of the composition.

10. The cheese composition of claim 1 wherein the vegetable oil triglyceride is present at between about 10% by weight to about 30% by weight of the composition.

11. The cheese composition of claim 1 wherein the vegetable oil triglyceride is present at between about 12% by weight to about 25% by weight of the composition.

12. The cheese composition of claim 1 wherein the vegetable oil triglyceride is present at between about 15% by weight to about 20% by weight of the composition.

13. The cheese composition of claim 1 wherein the hydrocolloid is present at between about 0.01% by weight to about 10% or more by weight of the composition.

14. The cheese composition of claim 1 wherein the hydrocolloid is present at between about 0.1% by weight to about 5% or more by weight of the composition.

15. The cheese composition of claim 1 wherein the hydrocolloid is present at between about 0.5% by weight to about 4% or more by weight of the composition.

16. The cheese composition of claim 2 wherein the cheese flavorant is present at between about 0.01% by weight to about 3% by weight of the composition.

17. The cheese composition of claim 2 wherein the cheese flavorant is present at between about 0.1% by weight to about 2% by weight of the composition.

18. The cheese composition of claim 2 wherein the cheese flavorant is present at between about 0.5% by weight to about 1% by weight of the composition.

19. The cheese composition of claim 2 wherein the starch is present at between about 0.1% by weight to about 5% by weight of the composition.

20. The cheese composition of claim 2 wherein the starch is present at between about 0.5% by weight to about 4% by weight of the composition.

21. The cheese composition of claim 2 wherein the starch is present at between about 1% by weight to about 3% by weight of the composition.

22. The cheese composition of claim 1 further comprising a dairy protein wherein the dairy protein is present at not more than about 5% by weight of the composition.

23. The cheese composition of claim 22 wherein the dairy protein is selected from the group consisting of casein, whey protein, and mixtures thereof.
